(19) United States
(12) Patent Application Publication
(10) Pub. No.: US 2016/0242370 A1
(43) Pub. Date: Aug. 25, 2016

(54) Automated Plant Irrigation System

(71) Applicant: Michael Kidakarn, City of Industry, CA (US)

(72) Inventor: Michael Kidakarn, City of Industry, CA (US)

(21) Appl. No.: 15/045,197

(22) Filed: Feb. 16, 2016

Related U.S. Application Data
(60) Provisional application No. 62/117,394, filed on Feb. 17, 2015.

(51) Int. Cl. A01G 27/00; A01G 7/04; A01G 9/02

(52) U.S. Cl. CPC A01G 27/003; A01G 9/02; A01G 7/045; A01G 27/008

(57) ABSTRACT

An automated plant irrigation system provides a habitable plant environment that automatically generates moisture, sunlight, and proper soil conditions for a plant, and allows the plant to be displayed and transferred between indoor and outdoor environments. The system provides generally artificial means to grow the plant, so that the plant can grow indoors. A plant container is used to contain and display the plant and soil. Once the plant has grown to a desired size and configuration, the plant container can transfer the plant outdoors for natural growth conditions and presentation. The container may include an ornamental design and be encapsulated by a transparent housing to enhance the display of the plant. A light source directionally emits artificial sunlight on the plant. A liquid dispensing device dispensed water and liquid nutrients onto the plant and soil. A control system automatically controls dispensing moisture and artificial sunlight.

### CROSS REFERENCE OF RELATED APPLICATIONS

This application claims the benefits of U.S. provisional application No. 62/117,394 filed Feb. 17, 2015 and entitled AUTOMATED PLANT IRRIGATION SYSTEM FOR DISPLAYING AND TRANSFERRING PLANTS BETWEEN INDOOR AND OUTDOOR ENVIRONMENTS, which provisional application is incorporated by reference herein in its entirety.

### FIELD OF THE INVENTION

The present invention relates generally to an automated plant irrigation system. More so, an automated plant irrigation system provides a habitable plant environment that automatically generates moisture, sunlight, and proper soil conditions for a plant, and allows the plant to be displayed and transferred between indoor and outdoor environments.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is recognized that plants are common additions to interior spaces, such as homes and offices. Typically, plants grow upwardly from a container that is filled with soil, compost or other hydroponic growth media. The plants are watered and exposed to natural or artificial light on a periodic basis. The water is brought to the pots directly by pipe, hose, or containers filled with water.

Like outdoor plants, conventional house plants require real or artificial light on a regular basis. Some house plants require more light than others, and must be positioned to face the sun or the artificial light source. This can be accomplished by rotating or moving the plants to provide their different sides with access to the sun or the artificial light source.

Plant installations may be mounted on vertical surfaces, i.e., perpendicular to the ground. This fixed orientation limits the exposure of the plants to natural or artificial sunlight. Because of this limited exposure, plant species secured to stationary vertical surfaces are chosen on the basis of their ability to thrive in these less than ideal light conditions. Even in the absence of sunlight, plants secured to either horizontal or vertical surfaces may readily grow in any direction, if electrically-powered artificial light is used.

Regular plant watering is necessary for proper care of the plant. The usual practice is to water the plant at regular intervals. This method produces large variations in the amount of water in the soil. A good deal of manual labor is required to repeatedly water large numbers of plants, as in commercial settings.

Generally, plant liquid dispensing devices provide a liquid reservoir below the grow pot and in contact with the soil. The water travels upward by a capillary attraction through the soil to the plant. However, all soils do not have the same ability to transfer water in this manner, and an insufficient supply of water may result. Ideally, a plant watering apparatus which supplies water to the plant regardless of the type of soil in the plant container would help automate the watering process.

Additional watering means involve hanging plant waterers, which comprise a flexible container and a rigid, cane-shaped tube. The bottom of the tube extends through the top of the container to the bottom of the container. Water is forced up the tube to the downwardly curved upper end to water the plant when the container is squeezed.

Other proposals have involved indoor and outdoor irrigation systems. The problem with these irrigation systems is that they are not automated, and also not very adaptable to use both indoors and outdoors. Even though the above cited plant irrigation systems and methods meet some of the needs of the market, an automated plant irrigation system provides a habitable plant environment that automatically generates moisture, sunlight, and proper soil conditions for a plant, and allows the plant to be displayed and transferred between indoor and outdoor environments is still desired.

### SUMMARY

Illustrative embodiments of the disclosure are generally directed to an automated plant irrigation system. In one embodiment, the automated plant irrigation system provides a habitable plant environment that automatically generates moisture, sunlight, and proper soil conditions for at least one plant and the soil in which the plant is potted, and allows the plant to be displayed and transferred between indoor and outdoor environments.

In another possible embodiment, the system provides generally artificial means to grow the plant, so that the plant can grow indoors. Once the plant has grown to a desired size and configuration, the plant is displayed in an attractive container indoors, or transferred outdoors for additional growth and presentation. Thus, whether indoors or outdoors, the plant receives all natural requirements for plant growth, including moisture in the form of a mist or spray, artificial sunlight, and proper soil characteristics.

The container is used to contain the plant and the soil used for growing the plant. The container may include a decorative plant container. The container may include an ornamental design. In some embodiments, a transparent housing encapsulates the container. In either case, the container and/or the transparent housing works to enhance the display of the plant.

In some embodiments, a liquid dispensing device is used to dispense a liquid, such as water, liquid nutrients, and the like, onto the plant and the soil. The liquid dispensing device comprises a liquid reservoir, a reservoir tube, and a sprayer. A pump may be used to force the liquid from the liquid reservoir to the soil through the reservoir tube.

In some embodiments, a light source is configured to emit a light, and specifically artificial sunlight onto the plant and the soil. The light source comprises at least one light emitting device for emitting the light. The light source is further configured to orient towards the at least one container. This may be accomplished by rotating the light source towards the plant and the soil.

A control system automatically controls dispensing moisture and artificial sunlight. The control system may include a processor, a timer, a signal receiver, and a signal transmitter. The timer enables automated control of the liquid dispensing device and the light source. The signal receiver and the signal transmitter enables remote control of the liquid dispensing device and the light source. Thus, the system enables the plant to be grown artificially indoors, and then transferred outdoors to more natural growing environments, and vice versa.

One aspect of the automated plant irrigation system, comprises:
a container, the container defined by a cavity and a handle, the cavity configured to form a containment reservoir, the container further configured to enable display of the contents of the cavity, the container further configured to be operational in an indoor environment and an outdoor environment;
a liquid dispensing device, the liquid dispensing device defined by a liquid reservoir, a reservoir tube, and a sprayer, the liquid dispensing device configured to enable dispensing of a liquid into the cavity of the container;
a pump, the pump configured to force the liquid from the liquid reservoir to the soil through the reservoir tube;
a light source, the light source defined by at least one light emitting device, the light source configured to emit a light, the light source further configured to orient towards the at least one container; and
a control system, the control system configured to regulate the liquid dispensing device and the light source, the control system comprising at least one member selected from the group consisting of: a processor, a timer, a signal receiver, and a signal transmitter,
wherein the control system is configured to automate the dispensing of the liquid and the emitting of the light.

In another aspect, the container has a cylindrical shape.

In another aspect, the container has a diameter of about thirty centimeters.

In another aspect, the cavity of the container is configured to contain at least one plant and soil.

In another aspect, the system further comprises a transparent housing, the transparent housing configured to encase the plant container and the at least one plant.

In another aspect, the transparent housing comprises a visual enhancement ornament and a scale.

In another aspect, the system further comprises an external power source.

In another aspect, the external power source includes at least one member selected from the group consisting of: a wall socket, a battery, and a solar panel.

In another aspect, the external power source transfers an electrical current to the control system and the liquid dispensing device through a power cable.

In another aspect, the artificial sunlight source includes at least one member selected from the group consisting of: fluorescent lights, incandescent lights, horticultural grow lights, and a plurality of blue LEDs that provide up to 10,000 LUX of light.

In another aspect, the system displays from a furniture in an indoor environment.

One objective of the present invention is to provide a decorative and functional growing environment for at least one plant, either in an indoor environment or transferrable to an outdoor environment.

Another objective is to provide an automated irrigation system that automatically provides moisture and artificial sunlight to at least one plant in a plant container.

Another objective is to provide a plant container that easily transfers between an indoor environment and an outdoor environment

Another objective is to provide a liquid dispensing device that sprays a fine mist on the at least one plant and the roots, and provides water for the soil from a liquid reservoir.

Another objective is to provide an artificial sunlight source that positions directly above the at least one plant.

Another objective is to provide a control system that automates the watering and artificial sunlight dispersing on the plant, such that a user does not need to be present to provide moisture or artificial sunlight.

Another objective is to provide at least one decorative plant container to overlay the plant container, such that an aesthetic effect is created.

### BRIEF DESCRIPTION OF THE DRAWINGS

The invention will now be described, by way of example, with reference to the accompanying drawings, in which:

FIG. 1 illustrates a perspective view of an exemplary automated plant irrigation system, in accordance with an embodiment of the present invention;

FIG. 2 illustrates a perspective view of an exemplary plant container positioning in at least one decorative plant container, in accordance with an embodiment of the present invention; and

FIG. 3 illustrates a perspective view of an exemplary plant container positioned inside a transparent housing and having a scale and a visual enhancement ornament, in accordance with an embodiment of the present invention.

Like reference numerals refer to like parts throughout the various views of the drawings.

### DETAILED DESCRIPTION OF THE INVENTION

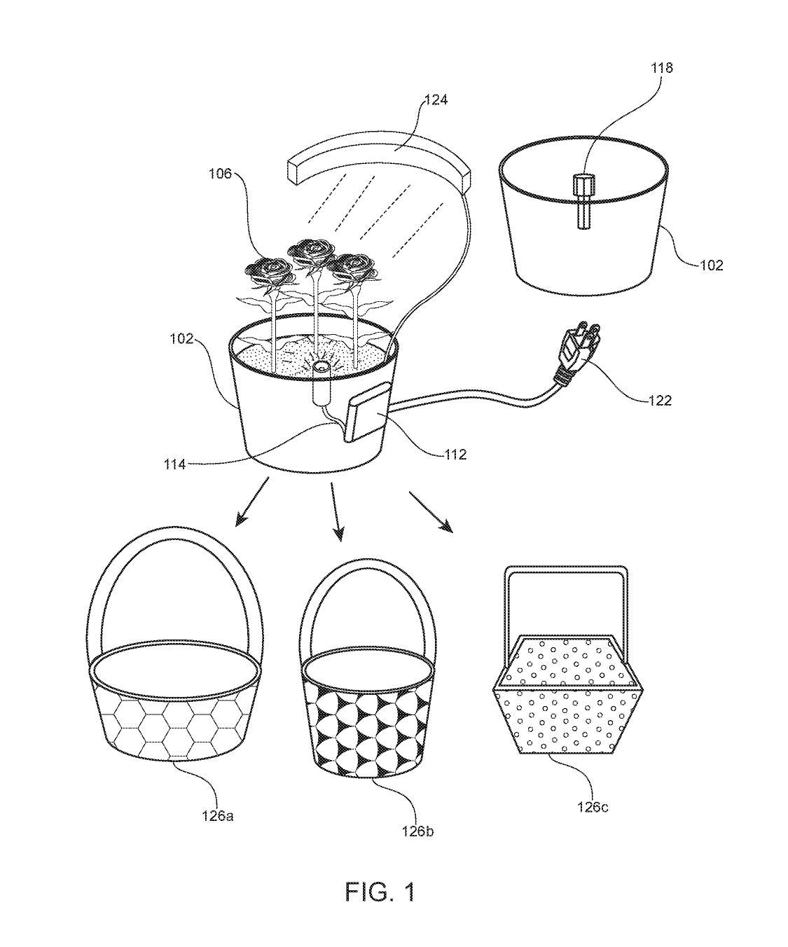

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-3, an automated plant irrigation system 100 provides a habitable plant environment that automatically generates moisture, sunlight, and proper soil conditions for at least one plant 106, and allows the plant 106 to be displayed and transferred between indoor and outdoor environments. The system 100 provides generally artificial means to grow the plant 106. In this manner, the plant 106 may be grown indoors.

The system is unique in that it provides great flexibility in growing and displaying healthy plants. For example, a plant 106 may be grown indoors while contained in a container 102 that is adaptable to contain and promote soil, moisture, nutrients, and other characteristics needed for healthy plant growth. Once the plant 106 has grown to a desired size and configuration indoors, the container is easily transferrable outdoors, such that the plant 106 may be displayed outdoors. The container 102 is decoratively configured for optimal visual enhancement during display, indoors or outdoors.

Furthermore, whether indoors or outdoors, the plant 106 receives all the natural requirements for healthy plant growth, including a liquid, such as water or a liquid nutrient. A liquid dispensing device 110 dispenses a liquid onto the plant 106 and the soil in the form of a mist or spray. A light source 124 is configured to emit an artificial sunlight and orient directly towards the plant and the soil. Thus, both the liquid and the artificial sunlight work to enhance and provide proper soil characteristics. In this manner, the plant 106 has an extended life since it is kept alive for a longer duration in an indoor irrigation environment, and potentially transferrable to a more natural outdoor environment. Thus, the system enables the plant to be grown artificially indoors, and then transferred outdoors to more natural growing environments, and vice versa.

In some embodiments, the system 100 may be used to irrigate the plant 106 for growth in an indoor environment. The plant 106 may include, without limitation, a flower, a vegetable, a fruit, an herb, a tree, a bush, foliage, and a bacteria. Those skilled in the art will recognize that the plant 106 requires sunlight for photosynthesis to convert the sunlight energy into chemical energy. The plant 106 also requires soil with appropriate amounts of Nitrogen, Phosphorous, and Potassium, as well as the correct pH level. Though, it is known in the art that each plant 106 may require a different quantity and type of soil and lighting.

The plant 106 also requires adequate moisture, including moisture in the soil, so that the roots 108 of the plant 106 can more efficiently absorb the nutrients from the soil through diffusion at the surface of the roots 108. Once inside the root tissue, the nutrients may be carried to the stem and leaves through an ATP process. In any case, the system 100 provides the requisite moisture to transfer nutrients from the soil to the plant 106.

By automatically providing artificial sunlight, moisture, and proper soil parameters, the system 100 allows the plant 106 to be irrigated indoors. The system 100 also allows the plant 106 to be displayed for a longer duration while simultaneously being irrigated and grown. The system 100 also allows the plant 106 to be transferred to a larger container 102, or to an outdoor environment. These advantages are especially useful because, often, providing fresh plants 106 that last for a duration and have healthy plant 106 characteristics can be problematic, as described below.

Those skilled in the art, in light of the present teachings, will recognize that gifting plants 106, such as flowers, fruits, and vegetables, is a popular manner of giving a gift. Often, holidays and special days, such as Valentine's, Easter, Christmas, birthdays, weddings, hospital stay, and funeral, are universally understood as appropriate moments to give flowers, fruits, and vegetables. However, with a large population obtaining properly irrigated flowers, fruit, and vegetables may be problematic.

For example, the plant 106 must but cut, processed, and removed from its natural growing habitat environment. This often results in a short lifespan for the plant 106. The plant 106 may last for a week before the plant 106 begins to die. In the case of flowers, the recipient may put the flower blossom in a vase of water to prolong the beauty and flower's life time temporarily. Typically, the rootless flower eventually blossoms, and quickly dies thereafter. Thus, the beauty of the flowers will die, the fruits and vegetables cannot be eaten in such a quick period of time, and the gift will be forgotten. Consequently, the flowers will be wasted, the fruits and vegetables will be wasted, uneaten, and thrown away. On a global scale, tons of waste in the floral and farming industry typically occurs.

Furthermore, artificial plants are often used indoors, such as in a home or office setting. The automated, indoor irrigation provided by the system 100 negates the need to use artificial plants. In this manner, the beauty, oxygen, and personal satisfaction of real plants 106 may be enjoyed more readily. In yet another problem, regular maintenance of the plant 106 is not always possible. Typically, a caretaker of the plant 106 maintains and follows a detailed log of the watering, sunlight, and habits required to sustain the growth of the plant 106. Should the caretaker forget to water the plant 106, the plant 106 may be overwatered, under watered, or not watered at all, causing the plant 106 to die. Should the caretaker not check the pH of the soil or not provide sufficient sunlight, the plant 106 will not live long. The system 100 automates these caretaking functions through a series of regulated water supply, artificial sunlight, and soil analysis.

As shown in FIG. 1, the plant 106 may be contained in a container 102 that is sized and dimensioned to grow the plant 106. The container 102 is defined by a cavity 136 that contains the plant 106 and soil. The container 102 may also be defined by a handle 104 that is used to carry the plant 106. The plant 106 can be grown in the container 102 for the full life of the plant 106, or the plant 106 may be removed from the container 102 after a predetermined duration. Once removed, the plant 106 may be planted in a larger container 102, at least one decorative plant container 126a, 126b, 126c, or in an outdoor environment. The container 102 may be reused for subsequent plants 106.

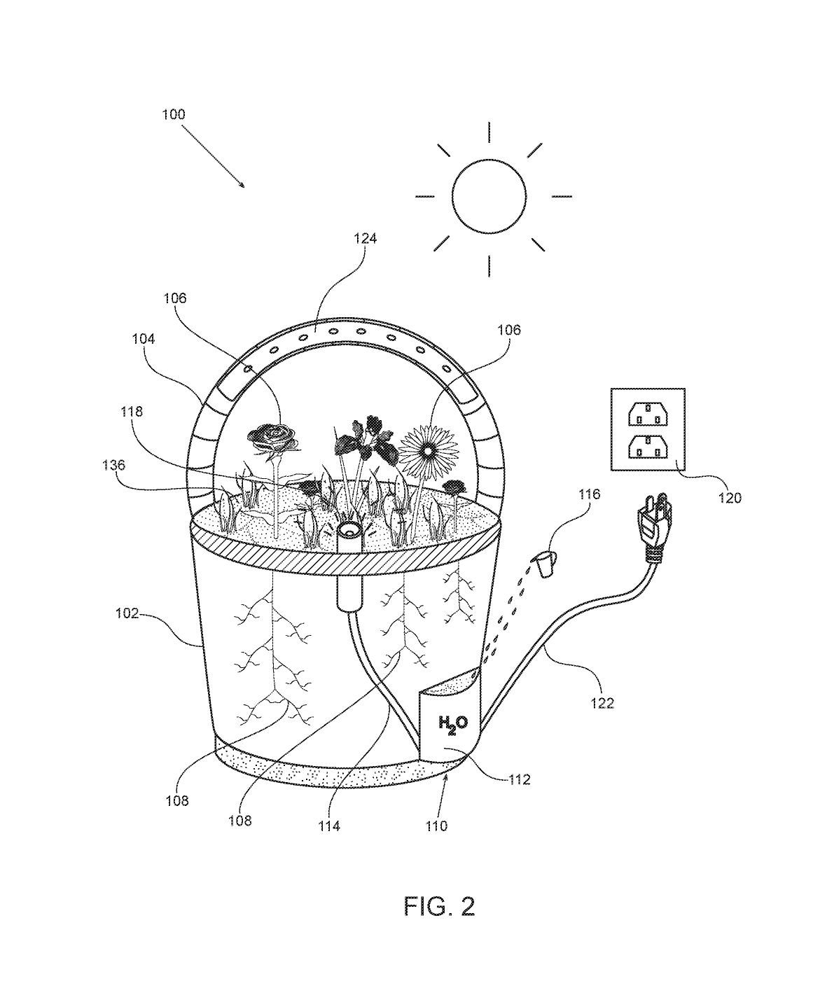

In some embodiments, the container 102 may include, without limitation, a pot having a generally round, cubicle, or rectangular shape. The container 102 may also include, without limitation, a basket, a barrel, a tub, a flowering pot, and a vase. In one possible embodiment, the container 102 has a diameter of about 30 centimeters. In any case, the additional components for automated irrigation and transferring of the plant 106 are integrated into the container 102. In one embodiment, a functional container 102, such as a plastic pot, may be transferrable to at least one decorative plant container 126a, 126b, 126c, such as a basket (FIG. 2).

The container 102 may have a decorative appearance, and include at least one ornamental member, such as ribbons, beads, braids, cards, bells, hearts, trinkets, and the like. The container 102 may also include a handle 104 that positions on the container 102 may facilitate carrying of the plant 106. The container 102 is also configured to retain the soil, from which the plant 106 receives nutrients. The roots 108 of the plant 106 may penetrate the soil and extend as deep as the container 102 allows. In one possible embodiment, the container 102 may fit into at least one decorative external basket 126a, 126b, 126c. The decorative external basket 126a, 126b, 126c may have no other function other than to receive the container 102, and provide an enhanced outer appearance. In one alternative embodiment, the container 102 is transparent, such that the soil and the roots 108 of the plant 106 are visible through the container 102.

The system 100 may provide the moisture component of irrigation through an automated liquid dispensing device 110. The liquid dispensing device 110, uniformly and in an automated manner, provides water and liquid nutrients to the plant 106. In one embodiment, the liquid dispensing device 110 provides moisture to the plant 106 in the form of a mist or spray. In another embodiment, the liquid dispensing device 110 provides moisture through a liquid reservoir 112 that is operatively connected to the soil through a reservoir tube 114.

In some embodiments, the liquid dispensing device 110 may include a pump (not shown) that forces water towards the plant 106 from an external water source 116 through the reservoir tube 114. The external water source 116 may provide the water, and may include, a water spigot, a barrel of water, a liquid nutrient dispenser, and a flower watering pot.

In one embodiment, the liquid dispensing device 110 comprises a sprayer 118. The sprayer 118 is disposed at the terminus of the reservoir tube 114. The sprayer 118 disperses the water on the plant 106 and soil in the form of a mist or spray. The mist provides a more gentle watering technique than a hard flow of water. This misting or light spraying effect is less disruptive to the soil and leaves of the plant 106. In another embodiment, a liquid reservoir 112 attaches to the container 102 for providing water directly to the soil. A reservoir tube 114 may carry water from the liquid reservoir 112 to the soil in the container 102.

The system 100 may further include a light source 124. The light source 124 is a light source that simulates sunlight where the unique characteristics of sunlight are needed, but where sufficient natural sunlight is not available or is not feasible. This is especially effective in cases such as the present system 100, where the plant 106 is grown at least partially indoors. The light source 124 may be disposed above the plant 106 so as to direct artificial sunlight onto the leaves, flowers, and fruits of the plant 106. In one embodiment, referenced in FIG. 1, the artificial light source positions on a bottom surface of the handle 104, orienting towards the plant 106.

The light source 124 may include, without limitation, fluorescent lights, incandescent lights, horticultural grow lights, and a plurality of blue LEDs that provide up to 10,000 LUX of light. The light source 124 may be adjustable so as to adjust the light intensity. The light source 124 may include an A/C adapter for connecting with a power source, such as a wall socket, a battery, or a solar panel. The control system used by the liquid dispensing device 110 is also operable for the light source 124. The control system can be preprogrammed to provide the desired amount and intensity of artificial sunlight.

In one possible embodiment, the wavelength of the artificial sunlight can be adjusted to generate optimal lighting conditions for different types of plants 106. This is because each plant 106 converts the light energy to chemical energy differently during photosynthesis. For example, blue wavelength light is ideal for foliage growth; red wavelength light is ideal for flowering and fruiting; and green wavelength light is generally useless since plants 106 have little use for green wavelengths and reflect them back, which is why leaves appear green.

In some embodiments, a control system (not shown) is programmable to regulate the water dispersion onto the plant 106. The control system automatically controls dispensing moisture and artificial sunlight. The control system may include a processor, a timer, a signal receiver, and a signal transmitter. The timer enables automated control of the liquid dispensing device and the light source. The signal receiver and the signal transmitter enables remote control of the liquid dispensing device and the light source. The processor controls the timer, the signal receiver, and the signal transmitter.

The control system can be preprogrammed to provide the desired amount and intensity of water from the sprayer 118 and/or the liquid reservoir 112. In this manner, the automated irrigation system 100 is substantially automated. An external power source 120 may provide power to the control system 100 and the liquid dispensing device 110. A power cable 122 may carry the electrical current.

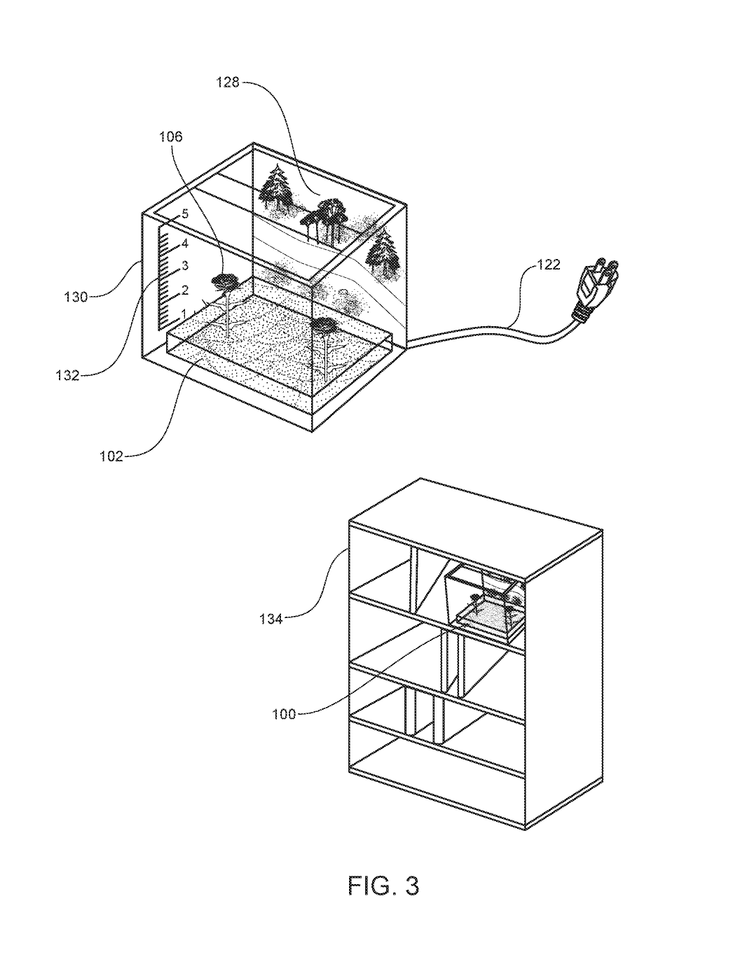

In one alternative embodiment, shown in FIG. 3, the container 102 may integrate a visual enhancement ornament 128 into the plant 106 to enhance the decorative appeal. The visual enhancement ornament 128 can be related or substantially similar to the plant 106. The visual enhancement ornament 128 may include, without limitation, an image, a video, an article of jewelry, an artificial flower, an animal, and a video. The container 102 may then display the plant 106 and the visual enhancement ornament 128 within the confines of the container 102. For example, without limitation, a fern plant 106 is irrigated and displayed inside a transparent container 102. An image of a jungle scene with similar ferns is placed on an inner sidewall or in proximity to the container 102. In this manner, the jungle image forms a background to the fern plant 106 when viewed from a front side of the container 102.

In another embodiment, the container 102 and the visual enhancement ornament 128 may be placed inside a transparent housing 130 to enable viewing. A scale 132 may be used inside the transparent housing 130 to measure the progressive growth of the plant 106. Furthermore, the system 100 may be positioned in a furniture 134, such as a bookcase, to provide a decorative enhancement. However, in other embodiments, variations of the visual enhancement ornament 128, transparent housing 130, and furniture 134 may be used. In any case, the system 100 automatically irrigates the plant 106 and facilitates the transfer of the container 102 between an indoor and outdoor environment.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. An automated plant irrigation system, the system comprising:
a container, the container defined by a cavity and a handle, the cavity configured to form a containment reservoir, the container further configured to enable display of the contents of the cavity, the container further configured to be operational in an indoor environment and an outdoor environment;
a liquid dispensing device, the liquid dispensing device defined by a liquid reservoir, a reservoir tube, and a sprayer, the liquid dispensing device configured to enable dispensing of a liquid into the cavity of the container;
a pump, the pump configured to force the liquid from the liquid reservoir to the soil through the reservoir tube;
a light source, the light source defined by at least one light emitting device, the light source configured to emit a light, the light source further configured to orient towards the at least one container; and
a control system, the control system configured to regulate the liquid dispensing device and the light source, the control system comprising at least one member selected from the group consisting of: a processor, a timer, a signal receiver, and a signal transmitter,
wherein the control system is configured to automate the dispensing of the liquid and the emitting of the light.

2. The system of claim 1, wherein the container is configured to enable containment of at least one plant.

3. The system of claim 2, wherein the container displays the at least one plant from a furniture in an indoor environment.

4. The system of claim 1, wherein the container has a generally cylindrical shape.

5. The system of claim 1, wherein the container comprises a visual enhancement ornament.

6. The system of claim 1, further including a transparent housing, the transparent housing configured to at least partially encase the container.

7. The system of claim 6, wherein the transparent housing comprises an ornament and a scale.

8. The system of claim 1, wherein the timer is configured to enable automated control of the liquid dispensing device and the light source.

9. The system of claim 1, wherein the signal receiver and the signal transmitter are configured to enable remote control of the liquid dispensing device and the light source.

10. The system of claim 1, wherein the at least one light emitting device is configured to emit artificial sunlight.

11. The system of claim 1, wherein the at least one light emitting device includes at least one member selected from the group consisting of: fluorescent lights, incandescent lights, horticultural grow lights, and a plurality of blue LEDs that provide up to 10,000 LUX of light.

12. The system of claim 1, wherein the liquid comprises water and/or a liquid nutrient.

13. The system of claim 1, wherein the system comprises an external power source.

14. The system of claim 13, wherein the external power source includes at least one member selected from the group consisting of: a wall socket, a battery, and a solar panel.

15. The system of claim 14, wherein the external power source transfers electrical current to the control system and the liquid dispensing device through a power cable.

16. An automated plant irrigation system, the system comprising:
a container, the container defined by a cavity and a handle, container further defined by a visual enhancement ornament, the container configured to enable containment of at least one plant and soil within the cavity, the plant container further configured to enable the display of the at least one plant and the transfer of the at least one plant between an indoor environment and an outdoor environment;
a transparent housing, the transparent housing configured to at least partially encase the container, the transparent housing configured to be at least partially transparent, the transparent housing comprising an ornament;
a liquid dispensing device, the liquid dispensing device defined by a liquid reservoir, a reservoir tube, and a sprayer, the liquid dispensing device enable dispensing of a liquid into the cavity of the container;
a pump, the pump configured to force the liquid from the liquid reservoir to the soil through the reservoir tube;
an artificial light source, the artificial light source defined by at least one light emitting device, the artificial light source configured to enable orientation towards the at least one plant, the artificial light source further configured to enable providing artificial sunlight to the at least one plant; and
a control system, the control system configured to regulate the liquid dispensing device and the artificial sunlight source, the control system comprising a processor, a timer, a signal receiver, and a signal transmitter,
wherein the dispensing of the moisture and the artificial sunlight is automated.

17. The system of claim 16, wherein the system comprises an external power source.

18. The system of claim 17, wherein the external power source transfers electrical current to the control system and the liquid dispensing device through a power cable.

19. The system of claim 16, wherein the at least one light emitting device is configured to emit artificial sunlight.

20. The system of claim 19, wherein the at least one light emitting device includes at least one member selected from the group consisting of: fluorescent lights, incandescent lights, horticultural grow lights, and a plurality of blue LEDs that provide up to 10,000 LUX of light.
